(19) United States
(12) Patent Application Publication
(10) Pub. No.: US 2021/0281742 A1
(43) Pub. Date: Sep. 9, 2021

(54) DOCUMENT DETECTIONS FROM VIDEO IMAGES

(71) Applicant: Hewlett-Packard Development Company, L.P., Spring, TX (US)

(72) Inventors: Ricardo Farias Bidart Piccoli, Porto Alegre (BR); Ricardo Ribani, Barueri (BR); Vinicius Lafourcade, Porto Alegre (BR); Joao Francisco Carvalho de Melo, Porto Alegre (BR); Rafael Borges, Porto Alegre (BR)

(73) Assignee: Hewlett-Packard Development Company, L.P., Spring, TX (US)

(21) Appl. No.: 17/256,502

(22) PCT Filed: Nov. 20, 2018
(86) PCT No.: PCT/US2018/061986

§ 371 Date: Dec. 28, 2020

(51) Int. Cl. H04N 5/232; G06K 9/00; G06T 7/246; G06T 7/13; G06T 5/00; G06K 9/46; G06K 9/32

(52) U.S. Cl. CPC H04N 5/23218; G06K 9/00442; G06T 7/246; H04N 5/232945; G06T 7/13; G06T 2207/10016; G06K 9/4604; G06K 9/3208; H04N 5/23229; G06T 2207/30176; G06T 5/002

(57) ABSTRACT

In example implementations, an apparatus is provided. The apparatus includes a video camera, a detection device, a tracking device, a display, and a processor. The video camera is to capture a video image of a plurality of documents. The detection device is to detect the plurality of documents in a frame of the video image. The tracking device is to track each one of the plurality of documents that is detected in a series of frames of the video image. The display is to generate a visual indicator around each one of the plurality of documents in the video image that is displayed. The processor is in communication with the video camera, the detection device, the tracking device, and the display to control execution of the video camera, the detection device, the tracking device, and the display.

### BACKGROUND

Documents are scanned by users to save paper documents as electronic files. Electronic files are easier to store and mange than physical printed documents. Documents can be scanned by various devices. For example, flatbed scanners or multi-function devices can scan documents inserted into the machines. Recently, mobile devices are being used as opposed to scanners. For example, a user may snap a photograph of a document and the document may be saved as an image.

### BRIEF DESCRIPTION OF THE DRAWINGS

FIG. 1 is a block diagram of an example system of the present disclosure;

FIG. 2 is a block diagram of an example apparatus for detecting multiple documents from a video image of the present disclosure;

FIG. 3 is a block diagram of an example display of the apparatus while detecting and tracking multiple documents from a video image of the present disclosure;

FIG. 4 is a flow chart of an example method for detecting and tracking multiple documents from a video image of the present disclosure; and

FIG. 5 is a block diagram of an example non-transitory computer readable storage medium storing instructions executed by a processor to detect and track multiple documents from a video image.

### DETAILED DESCRIPTION

Examples described herein provide an apparatus and method to automatically detect and track multiple documents within a video image captured by a mobile endpoint device. As discussed above, mobile endpoint devices are being used to capture images of documents rather than scanning the image in a traditional scanner. However, when multiple documents are included in a single image, the documents may not be separated out into separate files or images. It may be tedious and time consuming to capture an image of each document separately.

Examples herein provide an apparatus that can automatically detect and track multiple documents within a video image captured by the mobile endpoint device. For example, the user may capture several different documents in a live video capture. The mobile endpoint device may analyze each frame of the video image to identify each document or documents. Then the mobile endpoint device may track each document or documents while the video image is being continuously captured.

In one example, the mobile endpoint device may provide visual indicators around the documents that are detected and tracked in the video image. If the visual indicators correctly identify each document in the video image, the user may snap a still photograph of the documents. The mobile endpoint device may then generate a separate file or image for each document that was detected and tracked in the video images. As a result, a user may “scan” multiple documents using a single image captured by the mobile endpoint device.

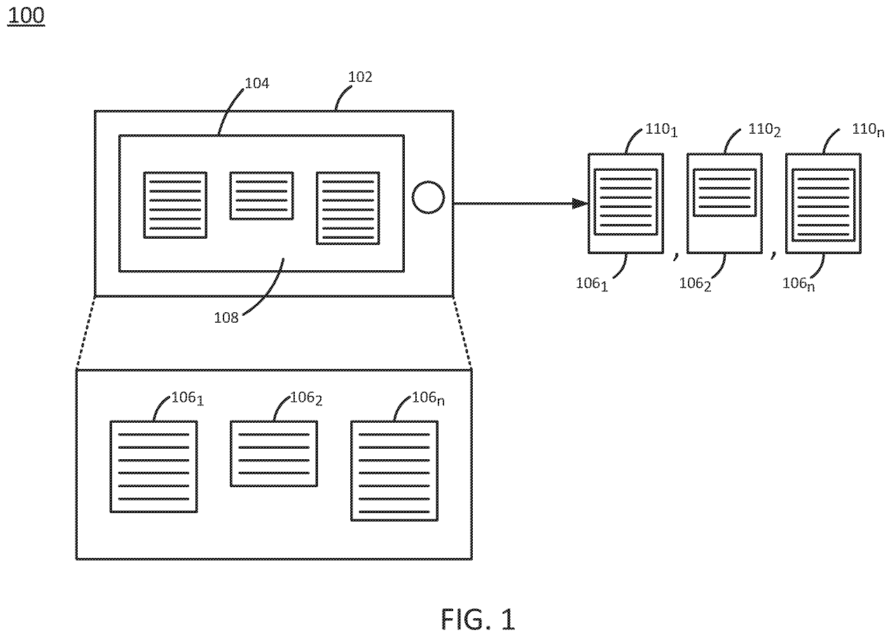

FIG. 1 illustrates an example a system 100 to detect multiple documents from a video image of the present disclosure. In one example, the system 100 may include a mobile endpoint device 102. The mobile endpoint device 102 may be a smart phone, a tablet computer, and the like.

The mobile endpoint device 102 may be used to capture a video image 108 of a plurality of documents 106₁ to 106ₙ (hereinafter also referred to individually as a document 106 or collectively as documents 106). The video image 108 may be displayed to a user on a display 104 of the mobile endpoint device 102.

In one example, the documents 106 may be any type of physical document or paper. The mobile endpoint device 102 may capture the video image 108 of the documents 106 and generate separate electronic files 110₁ to 110ₙ (hereinafter also referred to individually as an electronic file 110 or collectively as electronic files 110) for each one of the documents 106₁ to 106ₙ.

In other words, from the video image 108 that contains multiple documents, separate electronic files 110 may be generated. Said another way, the mobile endpoint device 102 may generate a separate electronic file 110 for each document 106 that is captured in a single frame of the video image 108.

To illustrate, the video image 108 may include three documents 106. The video image 108 may be analyzed (as discussed in further detail below) to detect each one of the three documents 106. Each document may then be separated out of the video image 108 and transformed into a separate electronic file 110. Said another way, separate electronic files 110 of the documents 106 may be generated from a single simultaneous scan of the multiple documents 106.

The electronic files 110 may then be stored for later use. For example, each electronic file 110 that represents a different document 106 may be viewed or processed separately from the other documents 106 that were captured in the same video image 108.

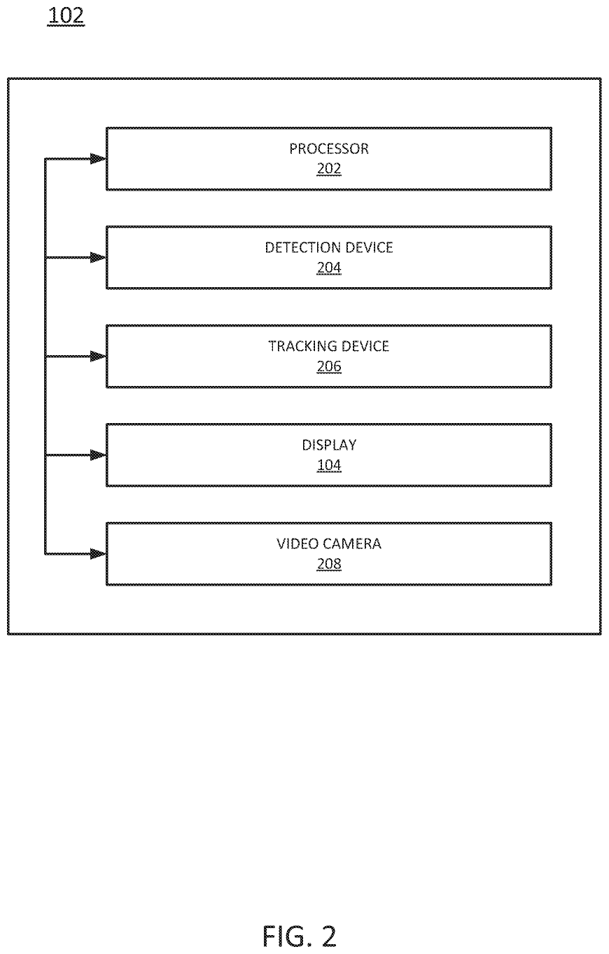

FIG. 2 illustrates a block diagram of the mobile endpoint device 102 of the present disclosure. In one example, the mobile endpoint device 102 may include a processor 202, a detection device 204, a tracking device 206, the display 104, and a video camera 208. It should be noted that the mobile endpoint device 102 has been simplified for ease of explanation and may include additional components that are not shown. For example, the mobile endpoint device 102 may include a non-transitory computer readable medium (e.g., random access memory, read only memory, a hard disk drive, and the like), radio transceivers, communication interfaces, power source or battery, and the like.

In one example, the processor 202 may be communicatively coupled to the detection device 204, the tracking device 206, the display 104 and the video camera 208. The processor 202 may control execution of the detection device 204, the tracking device 206, the display 104, and the video camera 208. For example, the processor 202 may execute instructions stored in memory to control operations associated with the detection device 204, the tracking device 206, the display 104, and the video camera 208.

In one example, the video camera 208 may be any type of red, green, blue (RGB) video camera. The video camera 208 may be used to capture a live video (e.g., a continuous sequence of video frames) or capture a photograph (e.g., a still image). The images captured by the video camera 208 may be displayed on the display 104. In one example, the video camera 208 may be used to capture the video image 108 of the documents 106, as described above and illustrated in FIG. 1.

In one example, the images captured by the video camera 208 may be forwarded to the detection device 204 and the tracking device 206 (e.g., via the processor 202). The detection device 204 may analyze each frame of the video image 108 to detect each one of the documents 106 in the video image 108. The tracking device 206 may analyze a sequence of frames of the video image 108 to track each document 106 that is identified by the detection device 204.

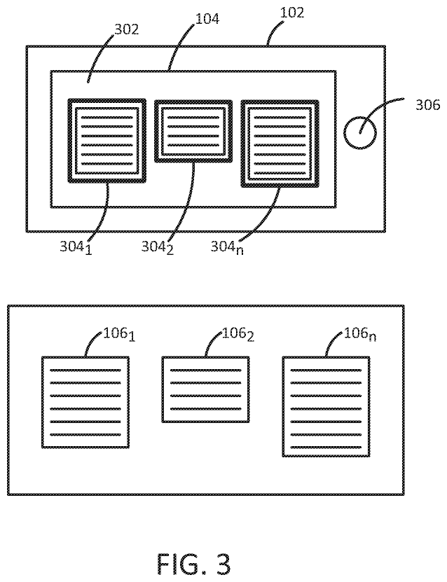

In one example, after the documents are detected, the display 104 may identify the detected documents 106 to the user via the display 104. FIG. 3 illustrates an example graphical user interface (GUI) of the display 104. In one example, a user may hold the mobile endpoint device 102 over the documents 106 such that the video camera 208 may capture a video image 302.

In one example, the mobile endpoint device 102 may include sensors that may detect an amount of light, contrast, color saturation, and the like. The video camera 208 may automatically adjust settings (e.g., brightness, focal length, exposure compensation, exposure length, and the like) based on the information collected by the sensors. In an example, the mobile endpoint device 102 may include a flash. The processor 202 may cause the flash to provide additional light if the sensor indicates that the ambient or environmental light is insufficient to capture a proper video image of the documents 106.

The video camera 208 may capture the video image 302. The video image 302 may be analyzed by the detection device 204 to detect the documents 106. The tracking device 206 may analyze the video image 302 on a frame-by-frame basis to track the documents 106 that are detected while the video image 302 is being captured.

When the documents 106 are detected, the processor 202 may cause a visual indicator 304 to be generated around each document 106 detected in the video image 302. For example, a visual indicator 304₁ may be displayed around the document 106₁, a visual indicator 304₂ may be displayed around the document 106₂, a visual indicator 304ₙ may be displayed around the document 106ₙ, and so forth.

In one example, the visual indicators 304 may be the same color or shape around each one of the documents 106. In another example, the visual indicators 304 may be a different color, a different shape, or a combination of both, around each one of the documents 106.

The visual indicator 304 may provide a cue to a user in the display 104 to confirm that the documents 106 have been correctly identified. If the user is satisfied that the documents 106 have been correctly identified, the user may press a shutter button 306 to capture a still image of the documents 106 via the video camera 208.

The detection device 204 and tracking device 206 may identify new documents 106 on the fly as documents are added or removed within the field of view of the video camera 208. As new documents are detected or documents are removed, the visual indicators 304 may be dynamically added or removed as the video image 302 is being captured.

In one example, the still image of the documents 106 may then be processed to separate out each document 106 from the still image. A separate electronic file 110 may then be generated for each document 106 that was separated out of the still image captured from the video image 302.

As discussed above, the detection device 204 may analyze each frame of the video image 108 or 302 to detect each document 106. In one example, the detection device 204 may perform pre-processing on a frame or image of video. The pre-processing may include removing color or converting the frame from a color image into a grayscale image, or applying a blur to the image to eliminate high-frequency noise (e.g., a 3×3 Gaussian blur kernel, a bilateral filter, and the like).

The detection device 204 may also detect edges in the frame of video. The edges may be detected by analyzing the pixels of the frame of video and identifying adjacent pixels that have a sharp change in brightness. The “sharp change” may be defined by a threshold. For example, a brightness change between adjacent pixels greater than the threshold may be detected to be an edge. Some other edge detection methods may include the Canny edge detector.

After the edges are detected, a contour detection is performed. The contour detection may analyze the frame of the video to find connected contours of edges to locate page candidates. In other words, the pixels that were detected to be possible edges are analyzed and paths of pixels that are potentially edges may be followed to form a polygonal approximation of the contour. After the contours are found, a set of geometric constraints may be used to determine the contours that may correspond to a document or page outline.

In one example, the constraints that may be used may include having a number of vertices between 4 and 7 in the polygonal approximation, that the polygonal approximation is convex, the area of the polygonal approximation is above a user-defined threshold (e.g., above a desired size or area), and that at least two opposing sides of the polygonal approximation are parallel. The amount of parallelism may be set by a user defined threshold (e.g. within 0-5 degrees of parallel).

In one example, the detection device 204 may perform perspective correction on each polygonal approximation that may be a page. For example, if the document appears to be rotated or elongated in a direction (e.g., the user held the video camera 208 at an angle rather than perpendicular to the images), the detection device 204 may correct the perspective. As a result, the documents may appear rectangular.

The coordinates of the polygonal approximations that may be pages or documents in the frame of video may then be forwarded to the tracking device 206. The tracking device 206 may then analyze sequence of frames of the video image 108 or 302 to track the potential documents based on the coordinates of the polygonal approximations obtained by the detection device 204.

In one example, the tracking device 206 may maintain a list of the polygonal approximations (hereinafter “polygons”) that may be potential documents that are detected by the detection device 204 for each frame. Each polygon of a respective list of polygons may be paired between two frames. For example, a list of polygons for a first frame of a video image may be paired with a list of polygons for a second frame of the video image. Said another way, a list of polygons of a current frame may be paired with a list of polygons of a previous frame.

After each polygon is paired, a distance between a centroid of the polygons may be calculated. If the distance is greater than a distance threshold, the polygon may be repaired with another polygon. In other words, the video camera 208 may have moved between the frames of the video image 108 or 302 and the polygon in a current frame may not be correctly paired with a polygon in the previous frame.

However, if the distance is below the distance threshold, the polygons may be determined to be correctly paired between frames. An interpolated quadrilateral may be generated based on a distance between the polygons. In one example, a Euclidean interpolation may be used. For example, a middle point of the coordinates of each pixel of the polygon may be used to create the outline of the interpolated quadrilateral.

In one example, the interpolated quadrilateral may be used to generate the visual indicator 304 around the respective documents 106. In other words, the visual indicator 304 may be drawn around an area located at an intermediate distance of the distance between the paired polygons.

In one example, the distance itself may be used to compute whether a polygon is closer to the first or the second frame. In other words, the determination if the polygon in the current frame is correctly paired with a polygon in the previous frame may be performed without the distance threshold.

To illustrate by example, if the distance is x units, the distance of x can be normalized to a value between 0 and 1 since a size of the video frame is known and, thus, the largest possible distance between two polygons. The normalized distance can be used as a weight to compute an actual position of the intermediate polygon. In other words, the normalized distance may be a weighted mean. Said another way, by interpreting the distance “x” as a measure of similarity or dissimilarity between the paired polygons, the coordinates of the intermediate polygon may be “x times” the coordinates of the first polygon plus “(1−x) times” the coordinates of the second polygon. As a result, the intermediate polygon may be a linear mixture of the pair. The final position may be somewhere in a line between the two polygons in the pair.

In one example, the scale may be adjusted such that the distance x may favor one polygon more than the other polygon depending on an original value of the distance x. In one implementation, the square root of the distance x may be taken that can still produce a value between 0 and 1, but “bends” the weights such that the calculation of the intermediate polygon may favor the first polygon (e.g., the polygon in a previous frame) more than the second polygon.

In one example, a frame may include a different number of polygons than a previous frame. For polygons that are not paired, a nil value may be added to the list of polygons of a frame having less polygons. For example, if a first frame has 10 polygons detected and a second frame has 9 polygons detected, the list of polygons for the second frame may be padded with a nil value.

In one example, a time-to-live value may be tracked for each polygon in the list of polygons. The time-to-live value may decrement with each subsequent frame that does not have a corresponding polygon to pair with a polygon from a previous frame that is analyzed. If the time-to-live value expires for a polygon, the polygon may be removed from the list and determined to be a false positive.

For example, the detection device 204 may have identified a polygonal approximation that could be a document in frame 1. The time-to-live value for the polygon is set to 10 in a list of polygons for frame 1 as the tracking device 206 analyzes a series of frames. The detection device 204 may not detect a corresponding polygonal approximation in frame 2. Thus, the polygonal approximation from frame 1 remains unpaired and the time-to-live value is decremented to 9. After 9 frames, no corresponding polygonal approximation is detected. As a result, the polygonal approximation from frame 1 may be removed and identified as a false positive.

The detection device 204 and the tracking device 206 may continuously repeat the functions described above for each frame of video captured by the video camera 208. As noted above, when a user confirms that the documents have been correctly identified in the video image 302 shown in the display 104, the user may press a shutter button 306 to capture a still image. The detection device 204 and the tracking device 206 may then stop processing frames of video. The still image may be analyzed and the documents 106 that are identified in the still image may be separated to form the separate electronic files 110 of the respective documents 106 in the video image 108 or 302.

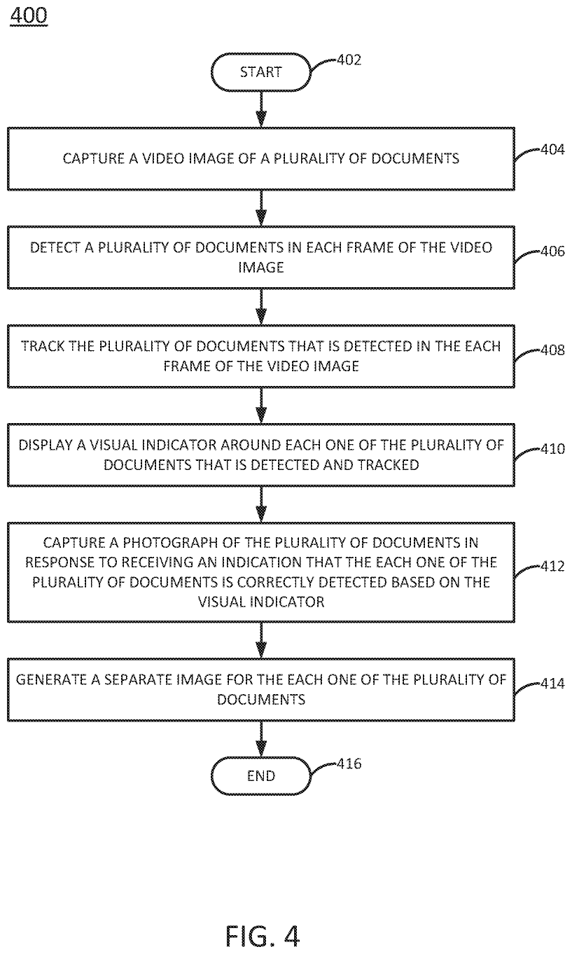

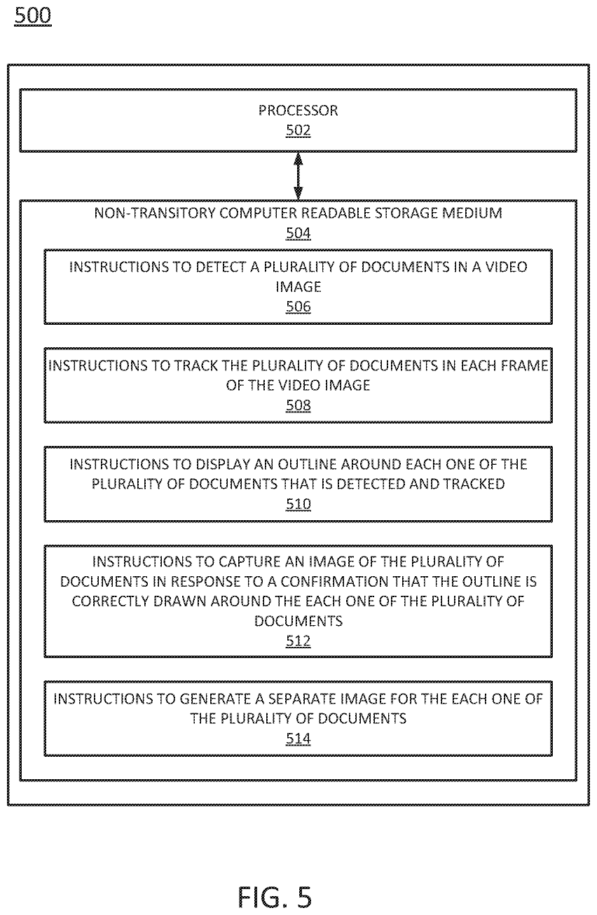

FIG. 4 illustrates a flow diagram of an example method 400 for detecting and tracking multiple documents from a video image. In an example, the method 400 may be performed by the apparatus 100, or the apparatus 500 illustrated in FIG. 5, and described below.

At block 402, the method 400 begins. At block 404, the method 400 captures a video image of a plurality of documents. For example, a user may want to scan a plurality of documents to form electronic versions of the document. However, rather than scanning each document separately, the method 400 may capture a single video image of multiple documents and generate separate electronic files of each document from the single video image.

At block 406, the method 400 detects a plurality of documents in each frame of the video image. In one example, a detection device in a mobile endpoint device may detect each document within each frame of the video image. For example, for each frame of the video image, a pre-processing, an edge detection, and a contour detection may be performed. Each one of the documents may then be detected based on the edge detection and contour detection.

In one example, the pre-processing may include removing color from the frame of the video image and applying a blur to eliminate high-frequency noise. In one example, the method 400 may also perform a perspective correction on each one of the plurality of documents that are detected. For example, some of the documents may be partially rotated or the image may have been captured at an angle causing a distortion.

At block 408, the method 400 tracks the plurality of documents that is detected in the each frame of the video image. For example, each document may be tracked from frame to frame to ensure that the document is correctly identified. In other words, assuming that the video camera is relatively still, the identified documents should have minimal movement from frame to frame.

In one example, the documents may be tracked by maintaining a list of polygons that are detected in each frame of the video image. Each polygon from a list of polygons from a first frame may then be paired to each polygon of a respective list of polygons in a second frame. The first frame and the second frame may be consecutive frames.

A distance between the paired polygons may be calculated, as described above. A visual indicator may then be drawn around an area located at an intermediate distance of the distance that is calculated.

As noted above, if the list of polygons between two frames is different, a nil value may be added to the list of polygons having a lower number polygons. A time to live value may be assigned to each polygon that is paired with a nil value. If no polygon is found in subsequent frames of the video image that pairs with the polygon having the time-to-live value before the time-to-live value reaches 0, then the polygon may be removed from the list of polygons. In other words, the polygon may have been a false positive detected in the frame.

At block 410, the method 400 displays a visual indicator around each one of the plurality of documents that is detected and tracked. The visual indicator may provide a cue to the user indicating that the documents have been identified in the video image.

At block 412, the method 400 captures a photograph of the plurality of documents in response to receiving an indication that the each one of the plurality of documents is correctly detected based on the visual indicator. For example, if the user believes that the documents are correctly identified in block 410, the user may press a shutter button to capture a still image. The processing of frames of video may be repeated (e.g., blocks 404-410) until the shutter button is activated to indicate that the documents are correctly detected.

At block 414, the method 400 generates a separate image for the each one of the plurality of documents. In other words, a separate file for each document may be generated from a single video image containing all of the documents. As a result, the user does not need to capture separate photos of each document to scan the document and generate an electronic file. Rather, the user may place all of the documents within a field of view of the video camera and the mobile endpoint device may automatically generate separate electronic files for each document. At block 416, the method 400 ends.

FIG. 5 illustrates an example of an apparatus 500. In an example, the apparatus 500 may be the apparatus 100. In an example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions.

In an example, the instructions 506 may include instructions to detect a plurality of documents in a video image. The instructions 508 may include instructions to track the plurality of documents in each frame of the video image. The instructions 510 may include instructions to display an outline around each one of the plurality of documents that is detected and tracked. The instructions 512 may include instructions to capture an image of the plurality of documents in response to a confirmation that the outline is correctly drawn around the each one of the plurality of documents. The instructions 514 may include instructions to generate a separate image for the each one of the plurality of documents.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a video camera to capture a video image of a plurality of documents;
a detection device to detect the plurality of documents in a frame of the video image;
a tracking device to track each one of the plurality of documents that is detected in a series of frames of the video image;
a display to generate a visual indicator around the each one of the plurality of documents in the video image that is displayed; and
a processor in communication with the video camera, the detection device, the tracking device, and the display to control execution of the video camera, the detection device, the tracking device, and the display.

2. The apparatus of claim 1, wherein the video camera is to capture a still photograph of the plurality of documents in response to a confirmation that is received that the each one of the plurality of documents is correctly detected.

3. The apparatus of claim 2, wherein the processor is to receive the photograph and generate a separate image for the each one of the plurality of documents.

4. The apparatus of claim 2, wherein the confirmation comprises detecting the activation of a shutter button.

5. The apparatus of claim 1, wherein the apparatus comprises a mobile endpoint device.

6. A method comprising:
capturing, by a processor, a video image of a plurality of documents;
detecting, by the processor, a plurality of documents in each frame of the video image;
tracking, by the processor, the plurality of documents that is detected in the each frame of the video image;
displaying, by the processor, a visual indicator around each one of the plurality of documents that is detected and tracked;
capturing, by the processor, a photograph of the plurality of documents in response to receiving an indication that the each one of the plurality of documents is correctly detected based on the visual indicator; and
generating, by the processor, a separate image for the each one of the plurality of documents.

7. The method of claim 6, wherein the detecting for each frame of the video image comprises:
performing, by the processor, pre-processing of a frame of the video image;
performing, by the processor, edge detection in the frame of the video image;
performing, by the processor, contour detection in the frame of the video; and
identifying, by the processor, the each one of the plurality of documents based on the edge detection and the contour detection.

8. The method of claim 7, further comprising:
performing, by the processor, a perspective correction on the each one of the plurality of documents.

9. The method of claim 7, wherein the pre-processing comprises:
removing, by the processor, color from the frame of the video image; and
applying, by the processor, a blur to eliminate high-frequency noise.

10. The method of claim 7, wherein the contour detection comprises:
identifying polygons formed by the edge detection that have a predefined number of vertices, have an area that is greater than a predefined threshold, and have two opposing sides that are parallel within a parallel degree threshold.

11. The method of claim 6, wherein the tracking comprises:
maintaining a list of polygons that are detected in each frame of the video image by the detecting;
pairing each polygon of a respective list of polygons in a first frame to each polygon of a respective list of polygons in a second frame;
calculating a distance between polygons that are paired; and
drawing the visual indicator around an area located at an intermediate distance of the distance that is calculated.

12. The method of claim 11, further comprising:
detecting the respective list of polygons in the first frame has a different number of polygons than the respective list of polygons in the second frame;
adding a nil value to the respective list of polygons having a lower number of polygons; and
assigning a time to live value to each polygon that is paired with a nil value.

13. A non-transitory computer readable storage medium encoded with instructions executable by a processor, the non-transitory computer-readable storage medium comprising:
instructions to detect a plurality of documents in a video image;
instructions to track the plurality of documents in each frame of the video image;
instructions to display an outline around each one of the plurality of documents that is detected and tracked;
instructions to capture an image of the plurality of documents in response to a confirmation that the outline is correctly drawn around the each one of the plurality of documents; and
instructions to generate a separate image for the each one of the plurality of documents.

14. The non-transitory computer readable storage medium of claim 13, wherein the video image is captured by a mobile endpoint device.

15. The non-transitory computer readable storage medium of claim 13, wherein the instructions to detect and the instructions to track are performed continuously as different documents are removed or added to the video image.
